(19) United States
(12) Patent Application Publication
(10) Pub. No.: US 2018/0160178 A1
(43) Pub. Date: Jun. 7, 2018

(54) NATURAL LANGUAGE DIALOG

(71) Applicant: fm marketing gmbh, Neumarkt am Wallersee (AT)

(72) Inventor: Regina Bernhaupt, Salzburg (AT)

(73) Assignee: fm marketing gmbh, Neumarkt am Wallersee (AT)

(21) Appl. No.: 15/829,503

(22) Filed: Dec. 1, 2017

(30) Foreign Application Priority Data
Dec. 6, 2016 (DE) 10 2016 123 547.4

(51) Int. Cl. H04N 21/472; G06F 17/30; H04N 21/422

(52) U.S. Cl. CPC H04N 21/472; H04N 21/42222; G06F 17/30026

(57) ABSTRACT

A method for controlling a multimedia appliance during a menu setup, which is initiated by a user based on the database query using a remote control for controlling the multimedia appliance, comprising acquiring the database query by way of an input of the user on the remote control; transmitting the database query to a database; receiving a response to the database query from the database after a processing time; playing an acoustic playback on the multimedia appliance during the processing time; and setting up the menu based on the response to the database query.

### REFERENCE TO RELATED APPLICATION

This application claims priority to German patent application no. 10 2016 123 547.4 filed Dec. 6, 2016, the entire disclosure of which is expressly incorporated herein by reference.

### FIELD OF THE INVENTION

The present invention relates to a method for controlling a multimedia appliance, a control device for carrying out the method, a multimedia system having the control device, and a computer program product.

### BACKGROUND OF THE INVENTION

A remote control, using which a multimedia appliance may be controlled by means of speech input, is known from EP 2 141 674 A1.

### SUMMARY OF THE INVENTION

It is the object of the present invention to improve the known method.

A method embodying aspects of the invention for controlling a multimedia appliance during a menu setup, which is initiated by a user based on a database query using a remote control for controlling the multimedia appliance, includes acquiring the database query by way of an input of the user on the remote control. The method further includes transmitting the database query to a database, receiving a response to the database query from the database after a processing time and playing an acoustic playback on the multimedia appliance during the processing time. Based on the response to the database query, the method comprises setting up the menu.

In an aspect, a control device for controlling a multimedia appliance during a menu setup, which is initiated by a user based on a database query using a remote control for controlling the multimedia appliance, includes a processor and a computer-readable memory. The memory stores instructions that, when executed by the processor, configure the control device to acquire the database query by way of an input of the user on the remote control, transmit the database query to a database, receive a response to the database query from the database after a processing time, play an acoustic playback on the multimedia appliance during the processing time, and set up the menu based on the response to the database query.

In another aspect, a multimedia system comprises a remote control having an input interface for inputting a control command via speech and a transmission interface for transmitting the input control command and a multimedia appliance having a reception interface for receiving the transmitted control command. The system also includes a control device for controlling the multimedia appliance during a menu setup, which is initiated by a user based on the control command using the remote control. The control device comprises a processor and a computer-readable memory storing instructions that, when executed by the processor, configure the control device to acquire the transmitted control command, transmit a database query corresponding to the acquired control command to a database, receive a response to the database query from the database after a processing time, play an acoustic playback on the multimedia appliance during the processing time, and set up the menu based on the response to the database query.

One or more non-transitory computer-readable media embodying further aspects of the invention have computer-executable instruction stored thereon that, when executed on a control device, operate to cause the control device to perform a method. The method includes acquiring a database query by way of an input of a user on a remote control, transmitting the database query to a database, receiving a response to the database query from the database after a processing time, playing an acoustic playback on a multimedia appliance during the processing time, and setting up a menu based on the response to the database query.

The object is achieved by the features of the independent claims. Preferred refinements are the subject matter of the dependent claims.

### BRIEF DESCRIPTION OF THE FIGURES

FIG. 1 shows a schematic illustration of a system made of a multimedia appliance and a remote control,

FIG. 2 shows a timeline having an acoustic playback according to one exemplary embodiment,

FIG. 3 shows a timeline having an acoustic playback according to a further exemplary embodiment, and

FIG. 4 shows a flowchart illustration of controlling a multimedia appliance according to one exemplary embodiment.

### DETAILED DESCRIPTION OF PREFERRED EMBODIMENTS

According to one aspect of the invention, a method for controlling a multimedia appliance during a menu setup, which is initiated by a user based on a database query using a remote control for controlling the multimedia appliance, comprises the steps of acquiring the database query by way of an input of the user on the remote control, transmitting the database query to a database, receiving a response to the database query from the database after a processing time, playing an acoustic playback on the multimedia appliance during the processing time, and setting up the menu based on the response to the database query.

The specified method is based on the consideration that a database query can be very time-consuming depending on the database size and the available channel capacity. Thus, if a menu is set up in accordance with a database query, it can thus be that the user has to wait a comparatively long time until he sees a result on the display screen. On the other hand, methods are available to the user by way of advanced input interfaces, using which a data query can be input into the multimedia system very rapidly. One of these methods is a database query input via speech, which is processed by means of speech recognition. The input of the database query is therefore accelerated, while the reaction speed of the multimedia system and the menu setup linked thereto with respect to the database query are subject to technical limits, however. This can result in a discrepancy between the expectations of the user for his database input and the technical capabilities of the multimedia system. The invention engages here with the proposal, in particular in the case of a database query via speech, to bridge the time until receiving a response to the database query which enables the menu setup using an acoustic playback on the multimedia appliance. In this manner, the expectation of the user that the menu is being set up as a response to his database query is subjectively decelerated, because the multimedia system communicates with him via a dialogue.

In one refinement of the specified method, a feature identifying the user is determined, wherein the acoustic playback is dependent on this feature identifying the user. For this purpose, the user can be addressed directly by his name, for example, or the acoustic playback can be performed depending on an emotional state of the user. The feature can be identified in this case in any desired way. The feature can thus be directly identified in that the user actively reveals himself at the remote control by logging in or the like. However, the user or features identifying the user can also be concluded indirectly by means of a suitable sensor system.

In another refinement of the specified method, the acoustic playback is first ended before the response to the database query is processed and/or the menu is set up.

In one special refinement of the specified method, the database query from the user comprises a command issued via speech, which is recognized by means of speech recognition. In this manner, a very extensive database query can also be identified in a very short time, because the user does not have to type in the database query cumbersomely via a keyboard.

In this case, the feature identifying the user can be determined based on the speech of the user, using which the user issues the command. Numerous items of information may be collected about the user via the speech of the user without additional sensors. Alternatively or additionally, the feature identifying the user can also be determined based on the signal of a sensor.

In still another refinement of the specified method, an identifier of the user can be stored in a memory after the determination of the feature identifying him. In this manner, the information about the user is available in the remote control at least as a reference during the next further use, so that the user can be identified more easily and rapidly.

The acoustic playback can furthermore also be output depending on the identifier of the user.

According to a further aspect of the invention, a control device is configured to carry out one of the specified methods.

In one refinement of the specified device, the specified device has a memory and a processor. In this case, the specified method is stored in the form of a computer program in the memory and the processor is provided for executing the method when the computer program is loaded from the memory into the processor.

According to a further aspect of the invention, a computer program comprises program code means to carry out all steps of the specified method when the computer program is executed on an electronic appliance or one of the specified devices.

According to a further aspect of the invention, a computer program product contains program code which is stored on a computer-readable data carrier and which, when it is executed on a data processing device, carries out the specified method.

According to a further aspect of the invention, a multimedia system comprises a remote control having an input interface for inputting a control command via speech and a transmission interface for transmitting the input control command, a multimedia appliance having a reception interface for receiving the transmitted control command, and one of the specified control devices for controlling the multimedia appliance.

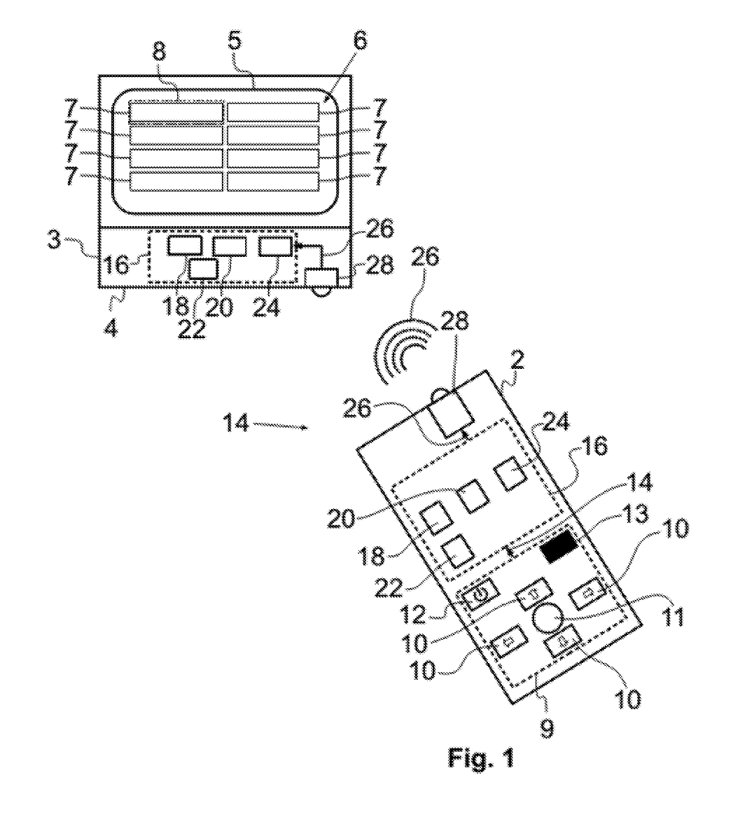

Reference is made to FIG. 1, which shows a remote control 2 for controlling a multimedia appliance 4 (also shown), in the form of a display screen 5 having a set-top box 3 connected thereto.

A menu 6 having multiple menu items 7 can be seen on the display screen 5. A focus element 8 can be moved using the remote control 2 in a manner to be described hereafter over the individual menu items 7.

The remote control 2 comprises an input interface 9, on which a directional pad having direction buttons 10 and a selection button 11, and also a power-on button 12 and a microphone 13 are arranged. Using the direction buttons 10 of the directional pad, the focus element 8 can be moved between the menu items 7. Using the selection button 11, the menu item 7, on which the focus element 8 is located upon pressing the selection button 11, can be activated. The multimedia device 4 can be activated and deactivated using the power-on button 12. Finally, speech commands can be input into the remote control via the microphone 13. To activate the entire system made of the remote control 2 and the multimedia appliance 4 for the input of speech commands, a button on the remote control 2, for example, the selection button 11, could be pressed.

Each menu item 7 stands for an item of media content which can be played back on the multimedia appliance 4. Items of media content include sources having audio/video data which can be displayed by the set-top box 3 on the display screen 5. These can be, for example, broadcast channels, data streams from the Internet, films, or the like. If a certain menu item 7 is approached using the direction buttons 10 and activated using the selection button 11, the set-top box 3 then displays the item of media content behind this menu item 7 on the display screen 5.

The menu 6 with its menu items 7 is adaptively embodied such that the items of media content behind the menu items 7 are dependent on a database query having a search command and input data, which is input by a user via speech into the microphone 13. Based on the search command, the set-top box 3 then processes the input data to form output data and displays the menu 6 with its menu items 7 depending on the output data. In the specific example, the user triggers a search in a database with the search command, and causes all available films on a desired thematic area to be displayed as menu items 7. The user can then select a menu item 7 and therefore one of the films found using the search by means of the direction buttons 10 and start the playback on the display screen 5 by pressing the selection button 11.

The database query with the search command and the input data is acquired as speech via the microphone 13 on the remote control 2 and processed by the set-top box 3. For this purpose, speech data 14 detected by the microphone 13 are transferred with the database query in the remote control 2 to a control device 16, also called a signal processing unit. The control device 16 in the remote control 2 comprises a memory 18, in which one or more computer programs are stored, and also one or more communicating processors 20, which retrieve and execute the computer program or programs from the memory 18. The control device 16 can optionally have a communication interface 22, to update and/or install the computer program or programs in the memory 18. Finally, the control device 16 also comprises at least one modulation circuit 24, to generate a suitable carrier signal 26, on which data can be transmitted to the set-top box 3 of the multimedia appliance 4. The fundamental structure of the control devices 16 is known in a relevant manner and will not be explained in greater detail hereafter.

The speech data 14 with the database query are processed by the computer program in the processor 20 and prepared for transmission. For this purpose, the computer program can already recognize the database query from the speech data 14 via speech recognition. Alternatively, the computer program can also transmit the speech data 14 to an external speech recognition program, which is provided at any arbitrary location on the remote control or anywhere in the network, and can obtain the recognized database query from this external speech recognition program. In the present embodiment, however, it is to be presumed that the speech recognition first takes place in the set-top box 3. The computer program in the processor 20 prepares the speech data 14 by way of suitable coding and thus makes them robust with respect to transmission errors. This is a procedure known per se. The coded speech data 14 are then played in the modulation circuit 24 onto the carrier signal 26 and transmitted using a transmission interface 28 to the set-top box 3. The transmission interface 28 can be embodied arbitrarily. It would be possible to embody it as an infrared, Bluetooth, and/or wireless network transmission interface.

The speech data 14 which are modulated and coded onto the carrier signal 26 are received in the set-top box 3 by a transmission interface 28 and transferred to a control device 16. In the control device 16 of the set-top box 3, the modulation of the speech data 14 on the carrier signal 26 is first reversed in a modulation circuit 24 and then they are transferred to a processor 20. A computer program stored in a memory 18 is also executed in the processor 20, which processes the demodulated speech data 18 in the set-top box 3. For this purpose, firstly the coding of the speech data 14 from the control device 16 in the remote control 2 is reversed.

Following the decoding, the computer program in the set-top box 3 recognizes, from the decoded speech data 14, the databank query of the user spoken via speech into the microphone 13 and subsequently executes the database query. The database having the above-mentioned items of media content, on which the database query is based, can be located at an arbitrary location, thus, for example, in the set-top box 3 itself, in the Internet, or also at any arbitrary other location, which is connected via a network (not shown), for example, to the set-top box 3. As a result of the database query, the computer program receives available items of media content which correspond to the desired search area of the user and displays these available items of media content as the individual menu items 7 of the menu 6 on the display screen 5.

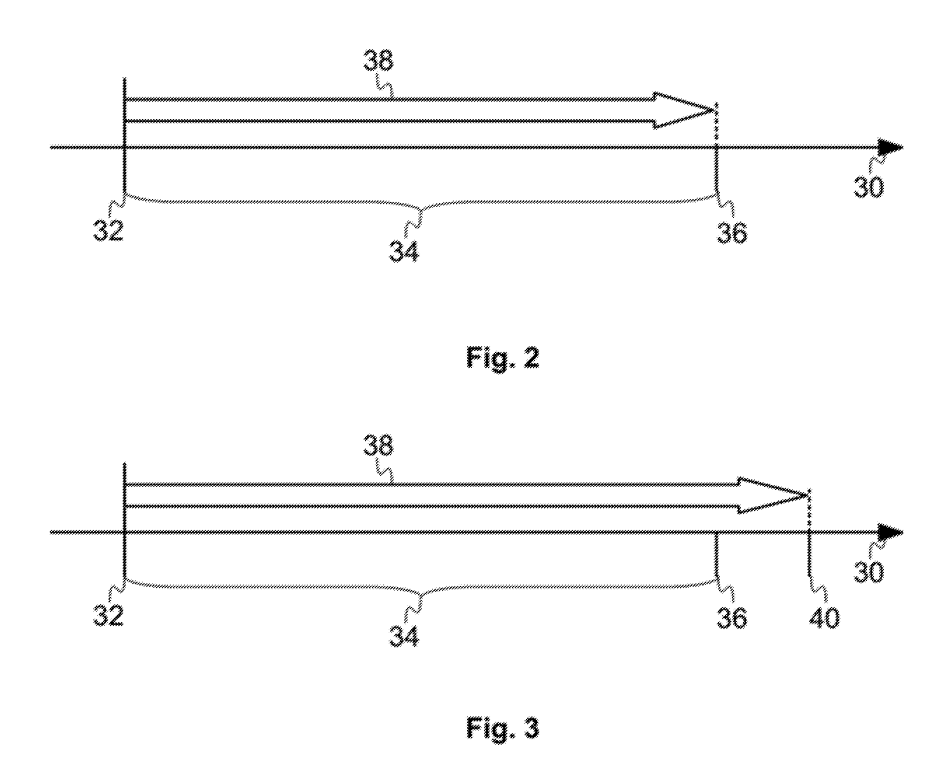

For the above-mentioned method, the above-mentioned multimedia system made of the remote control 2 and the multimedia appliance 4 requires, from the recording of the speech data 14 at the microphone 13 until the display of the result as menu items 7 on the menu 6 of the display screen 5, a certain processing time, which is to be illustrated on the basis of FIG. 2, on which a timeline 30 is shown. If the user inputs the database query via the microphone 32 at a first point in time 32, the transmission of the speech data 14 from the remote control 2 to the set-top box 3 and the database query in the set-top box 3 thus lasts the above-mentioned processing time 34, so that the menu 6 with the menu items 7 adapted to the database query is displayed at a second point in time 36, which is after the first point in time 32 by the processing time 34.

A user who would define the database query using a keyboard on the remote control 2 would accordingly require a long time for the input. Even if the database query lasted several tens of seconds, or perhaps even a minute, this would not seem excessively long to the user because of the preceding longer input of the database query, because he has already required a long time for a long-lasting input. It appears different if the user defines the database query via speech and therefore the speech data 14. He can define the database query in a very short timeframe here and expects a correspondingly rapid response from the multimedia system 4. To decelerate this expectation of the user, the present embodiment proposes having the user enter a dialogue on the multimedia appliance 4 after the input of the database query and therefore during the processing time 34 and to output an acoustic playback 38 to him from the multimedia appliance.

If the acoustic playback 38 should last longer than the processing time 34 of the database query, the setup of the menu 6 should thus take place at a third point in time 40 after the second point in time 36, at which the acoustic playback has played back completely. This is indicated in FIG. 3.

Vice versa, multiple acoustic playbacks 38 can also be concatenated if the processing time 34 lasts longer than one acoustic playback 38. If the last played acoustic playback 38 is then supposed to last longer than the second point in time 36, the setup of the menu 6 is thus first supposed to begin after the third point in time 40, similarly to the above embodiment.

Jointly with the setup of the menu 6, a further acoustic playback can be output to the user after the acoustic playback 38, which communicates the result of the database query to him, for example.

This acoustic playback 38 is preferably embodied personalized for the respective user, who initiates the database query. The personalization can be performed typically for a special user or for a certain user group.

Upon an assignment to a special user, the control device 16 of the set-top box 5 recognizes the user and then addresses him with individualizing features, for example, his name. The features individualizing the user can also be stored in the memory 18. The recognition of the user can take place in any desired manner, for example, by prior logging in of the user at the remote control and/or an analysis of the speech data.

Alternatively or additionally, the user can also be assigned to a specific user group. The speech data 14 can also be used for this purpose, for example. An emotional state of the user may be ascertained from the speech data 14, for example, which then assigns him to a specific user group, such as happy, impatient, or the like.

In principle, however, the recognition of the user can also be performed via further sensors, for example, a fingerprint scanner.

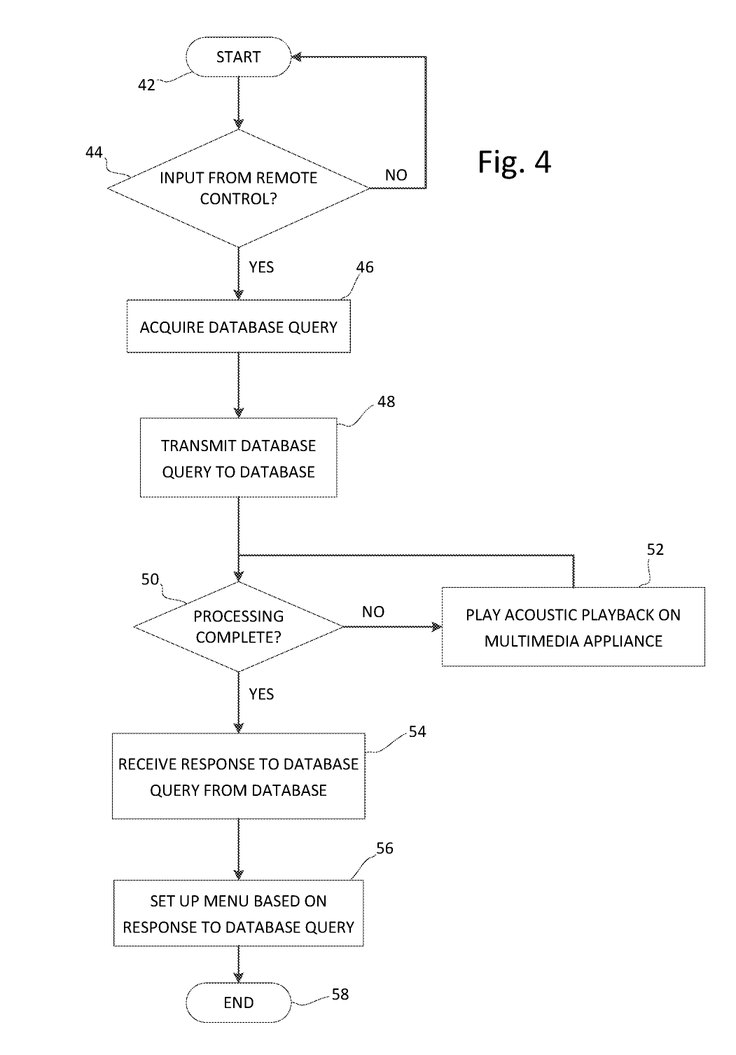

FIG. 4 shows a flowchart illustration of controlling multimedia appliance 4 according to one exemplary embodiment. The flow chart begins at 42. The user then initiates control device 16 during menu setup using the remote control 2 at 44. In response to user input, a database query is acquired at 46 and transmitted to a database at 48. Processing commences at 50. During processing, the multimedia appliance 4 plays acoustic playback 38 at 52. After processing is complete, a response to the database query is received from the database at 54. Then the menu setup is performed at 56 based on the response to the database query. The flow chart ends at 58

In addition to the embodiments described above, embodiments of the present disclosure may comprise a special purpose computer including a variety of computer hardware, as described in greater detail below.

Embodiments within the scope of the present disclosure also include computer-readable media for carrying or having computer-executable instructions or data structures stored thereon. Such computer-readable media can be any available media that can be accessed by a special purpose computer and comprises computer storage media and communication media. By way of example, and not limitation, computer storage media include both volatile and nonvolatile, removable and non-removable media implemented in any method or technology for storage of information such as computer readable instructions, data structures, program modules or other data. Computer storage media are non-transitory and include, but are not limited to, random access memory (RAM), read only memory (ROM), electrically erasable programmable ROM (EEPROM), compact disk ROM (CD-ROM), digital versatile disks (DVD), or other optical disk storage, solid state drives (SSDs), magnetic cassettes, magnetic tape, magnetic disk storage, or other magnetic storage devices, or any other medium that can be used to carry or store desired non-transitory information in the form of computer-executable instructions or data structures and that can be accessed by a computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The following discussion is intended to provide a brief, general description of a suitable computing environment in which aspects of the disclosure may be implemented. Although not required, aspects of the disclosure will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that aspects of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing aspects of the disclosure includes a special purpose computing device in the form of a conventional computer, including a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory computer storage media, including nonvolatile and volatile memory types. A basic input/output system (BIOS), containing the basic routines that help transfer information between elements within the computer, such as during start-up, may be stored in ROM. Further, the computer may include any device (e.g., computer, laptop, tablet, PDA, cell phone, mobile phone, a smart television, and the like) that is capable of receiving or transmitting an IP address wirelessly to or from the internet.

The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The magnetic hard disk drive, magnetic disk drive, and optical disk drive are connected to the system bus by a hard disk drive interface, a magnetic disk drive-interface, and an optical drive interface, respectively. The drives and their associated computer-readable media provide nonvolatile storage of computer-executable instructions, data structures, program modules, and other data for the computer. Although the exemplary environment described herein employs a magnetic hard disk, a removable magnetic disk, and a removable optical disk, other types of computer readable media for storing data can be used, including magnetic cassettes, flash memory cards, digital video disks, Bernoulli cartridges, RAMs, ROMs, SSDs, and the like.

Communication media typically embody computer readable instructions, data structures, program modules or other data in a modulated data signal such as a carrier wave or other transport mechanism and includes any information delivery media.

Program code means comprising one or more program modules may be stored on the hard disk, magnetic disk, optical disk, ROM, and/or RAM, including an operating system, one or more application programs, other program modules, and program data. A user may enter commands and information into the computer through a keyboard, pointing device, or other input device, such as a microphone, joy stick, game pad, satellite dish, scanner, or the like. These and other input devices are often connected to the processing unit through a serial port interface coupled to the system bus. Alternatively, the input devices may be connected by other interfaces, such as a parallel port, a game port, or a universal serial bus (USB). A monitor or another display device is also connected to the system bus via an interface, such as video adapter. In addition to the monitor, personal computers typically include other peripheral output devices (not shown), such as speakers and printers.

One or more aspects of the disclosure may be embodied in computer-executable instructions (i.e., software), routines, or functions stored in system memory or nonvolatile memory as application programs, program modules, and/or program data. The software may alternatively be stored remotely, such as on a remote computer with remote application programs. Generally, program modules include routines, programs, objects, components, data structures, etc. that perform particular tasks or implement particular abstract data types when executed by a processor in a computer or other device. The computer executable instructions may be stored on one or more tangible, non-transitory computer readable media (e.g., hard disk, optical disk, removable storage media, solid state memory, RAM, etc.) and executed by one or more processors or other devices. As will be appreciated by one of skill in the art, the functionality of the program modules may be combined or distributed as desired in various embodiments. In addition, the functionality may be embodied in whole or in part in firmware or hardware equivalents such as integrated circuits, application specific integrated circuits, field programmable gate arrays (FPGA), and the like.

The computer may operate in a networked environment using logical connections to one or more remote computers. The remote computers may each be another personal computer, a tablet, a PDA, a server, a router, a network PC, a peer device, or other common network node, and typically include many or all of the elements described above relative to the computer. The logical connections include a local area network (LAN) and a wide area network (WAN) that are presented here by way of example and not limitation. Such networking environments are commonplace in office-wide or enterprise-wide computer networks, intranets and the Internet.

When used in a LAN networking environment, the computer is connected to the local network through a network interface or adapter. When used in a WAN networking environment, the computer may include a modem, a wireless link, or other means for establishing communications over the wide area network, such as the Internet. The modem, which may be internal or external, is connected to the system bus via the serial port interface. In a networked environment, program modules depicted relative to the computer, or portions thereof, may be stored in the remote memory storage device. It will be appreciated that the network connections shown are exemplary and other means of establishing communications over wide area network may be used.

Preferably, computer-executable instructions are stored in a memory, such as the hard disk drive, and executed by the computer. Advantageously, the computer processor has the capability to perform all operations (e.g., execute computer-executable instructions) in real-time.

The order of execution or performance of the operations in embodiments illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of aspects of the disclosure.

Embodiments may be implemented with computer-executable instructions. The computer-executable instructions may be organized into one or more computer-executable components or modules. Aspects of the disclosure may be implemented with any number and organization of such components or modules. For example, aspects of the disclosure are not limited to the specific computer-executable instructions or the specific components or modules illustrated in the figures and described herein. Other embodiments may include different computer-executable instructions or components having more or less functionality than illustrated and described herein.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained. As various changes could be made in the above products and methods without departing from the scope of the invention, it is intended that all matter contained in the above description and shown in the accompanying drawings shall be interpreted as illustrative and not in a limiting sense.

What is claimed is:

1. A method for controlling a multimedia appliance during a menu setup, which is initiated by a user based on a database query using a remote control for controlling the multimedia appliance, comprising:
acquiring the database query by way of an input of the user on the remote control;
transmitting the database query to a database;
receiving a response to the database query from the database after a processing time;
playing an acoustic playback on the multimedia appliance during the processing time; and
setting up the menu based on the response to the database query.

2. The method as set forth in claim 1, further comprising setting up the menu after the acoustic playback is ended.

3. The method as set forth in claim 1, wherein a feature identifying the user is determined, and the acoustic playback is dependent on the feature identifying the user.

4. The method as set forth in claim 3, wherein the database query comprises a command issued by the user via speech, which is recognized by means of speech recognition.

5. The method as set forth in claim 4, wherein the feature identifying the user is determined based on the speech of the user using which the user issues the command.

6. The method as set forth in claim 3, wherein the feature identifying the user is determined based on the signal of a sensor.

7. The method as set forth in claim 3, wherein an identifier of the user is stored in a memory after the determination of the feature identifying the user.

8. A control device for controlling a multimedia appliance during a menu setup, which is initiated by a user based on a database query using a remote control for controlling the multimedia appliance, comprising:
a processor; and
a computer-readable memory storing instructions that, when executed by the processor, configure the control device to:
acquire the database query by way of an input of the user on the remote control;
transmit the database query to a database;
receive a response to the database query from the database after a processing time;
play an acoustic playback on the multimedia appliance during the processing time; and
set up the menu based on the response to the database query.

9. The control device as claimed in claim 8, wherein the instructions stored in the computer-readable memory, when executed by the processor, further configure the control device to set up the menu after the acoustic playback is ended.

10. The control device as claimed in claim 8, wherein a feature identifying the user is determined, and the acoustic playback is dependent on the feature identifying the user.

11. The control device as claimed in claim 10, wherein the database query comprises a command issued by the user via speech, which is recognized by means of speech recognition.

12. The control device as claimed in claim 11, wherein the feature identifying the user is determined based on the speech of the user using which the user issues the command.

13. The control device as claimed in claim 10, wherein the feature identifying the user is determined based on the signal of a sensor.

14. The control device as claimed in claim 10, wherein an identifier of the user is stored in the memory after the determination of the feature identifying the user.

15. A multimedia system, comprising:
a remote control having an input interface for inputting a control command via speech and a transmission interface for transmitting the input control command;
a multimedia appliance having a reception interface for receiving the transmitted control command; and
a control device for controlling the multimedia appliance during a menu setup, which is initiated by a user based on the control command using the remote control, the control device comprising:
a processor; and
a computer-readable memory storing instructions that, when executed by the processor, configure the control device to:
acquire the transmitted control command;
transmit a database query corresponding to the acquired control command to a database;
receive a response to the database query from the database after a processing time;
play an acoustic playback on the multimedia appliance during the processing time; and
set up the menu based on the response to the database query.

16. The multimedia system as claimed in claim 15, wherein the instructions stored in the computer-readable memory, when executed by the processor, further configure the control device to set up the menu after the acoustic playback is ended.

17. The multimedia system as claimed in claim 15, wherein a feature identifying the user is determined, and the acoustic playback is dependent on the feature identifying the user.

18. One or more non-transitory computer-readable media having computer-executable instruction stored thereon that, when executed on a control device, operate to cause the control device to perform a method comprising:
acquiring a database query by way of an input of a user on a remote control;
transmitting the database query to a database;
receiving a response to the database query from the database after a processing time;
playing an acoustic playback on a multimedia appliance during the processing time; and
setting up a menu based on the response to the database query.

19. One or more non-transitory computer-readable media as set forth in claim 18, wherein the method further comprises setting up the menu after the acoustic playback is ended.

20. One or more non-transitory computer-readable media as set forth in claim 18, wherein a feature identifying the user is determined, and the acoustic playback is dependent on the feature identifying the user.
